(19) United States
(12) Patent Application Publication
(10) Pub. No.: US 2026/0124887 A1
(43) Pub. Date: May 7, 2026

(54) LINKAGE MECHANISM TO DRIVE COVER OF CURTAIN CONTAINER OF ELECTRIC SUNSHADE FOR MOTORIZED VEHICLES

(71) Applicant: MACAUTO INDUSTRIAL CO., LTD., Tainan City (TW)

(72) Inventors: Paul LIN, Tainan City (TW); Hung Ming YEN, Tainan City (TW); Yu Hsien CHIEN, Tainan City (TW); Tsung Yi Chuang, Tainan City (TW)

(21) Appl. No.: 19/374,324

(22) Filed: Oct. 30, 2025

(30) Foreign Application Priority Data
Nov. 7, 2024 (CN) 202411581133.2

(51) Int. Cl. B60J 1/20

(52) U.S. Cl. CPC B60J 1/2091

(57) ABSTRACT

A linkage mechanism applied to an electric sunshade for motorized vehicles has a linkage unit and an elastic connector. The linkage unit is swingable, between a curtain container and a curtain track, and under a cover of the curtain container. The linkage unit has an arm and a pressed part beside the arm and at the curtain track. The elastic connector is connected between the arm and the cover such that the pressed part is able to be pressed by a sliding block to lower and to restore a position of the pressed part. The elastic connector is configured to pull the cover to close the opening of the curtain container when the arm swings downward. Wherein, the cover rotates upward to open by an elastic torsion force when the sliding block moves upward to detach from the pressed part.

### BACKGROUND OF THE INVENTION

### 1. Field of the Invention

The present invention relates to an electric sunshade for motorized vehicles, and more particularly to a linkage mechanism of an electric sunshade for motorized vehicles that can synchronize movements of a curtain and a cover of a curtain container of the electric sunshade.

### 2. Description of Related Art

An electric curtain device currently applied to windows of motorized vehicles mainly includes a curtain fabric, a retracting assembly, and a driving mechanism. The driving mechanism drives a strip of the curtain fabric to move along curtain tracks upward extending and fixed at both sides of a window of a motorized vehicle.

When the curtain fabric is at a static position, it is retracted into a curtain container under a window glass. A top of the curtain container is equipped with a cover combined with a torsion spring. The cover is connected to two linkage mechanisms allowing the cover to automatically open and close an opening of the curtain container at a top thereof in coordination with expanding the curtain fabric and retracting the curtain fabric.

The aforementioned linkage mechanisms can be driven by the driving mechanism. A linking block of each linkage mechanism is disposed at a lower section of a corresponding curtain track and is connected to the cover via a spring. When the curtain fabric and the strip thereof are driven and retracted into the curtain container, the strip presses the linking block and the cover closes the opening of the curtain container to prevent a foreign object from falling into the curtain container.

The conventional linkage mechanisms mentioned above are connected to the cover, are driven by the driving mechanism, and cooperate with the torsion spring to open and close the cover in coordination with expanding the curtain fabric and retracting the curtain fabric. However, the two sides of the window of a motorized vehicle are curved and upward extend toward each other. The curtain fabric has a shape with a top narrower than a bottom thereof to correspond to the window in shape. Lateral ends of the curtain container are respectively remote from the curtain tracks. The spring connected between the cover and a corresponding linking block disposed at the lower section of said curtain track biases significantly. Therefore, elastic force provided by the spring can hardly be directly transmitted to the cover. Accordingly, the linking block has difficulty smoothly moving in a corresponding curtain track. The conventional linkage mechanisms cannot easily drive the cover to open and close.

To overcome the shortcomings of the conventional linkage mechanism, the present invention provides a linkage mechanism to mitigate or obviate the aforementioned problems.

### SUMMARY OF THE INVENTION

The main objective of the present invention is to provide a linkage mechanism of an electric sunshade for motorized vehicles that can smoothly drive a cover of a curtain container to open and close.

The linkage mechanism relates to an electric sunshade for motorized vehicles. The linkage mechanism is assembled to a curtain track, adjacent to a curtain container, and connected to a cover of the curtain container. The linkage mechanism can open and close the cover by being driven by an end of a strip moving along the curtain track. Wherein, the linkage mechanism has a linkage unit and an elastic connector. The linkage unit is swingable, is disposed between an end of the curtain container and the curtain track, under the cover, and has an arm and a pressed part disposed at a side of the arm. The pressed part is disposed at a lower section of the curtain track. The elastic connector is connected between the arm and the cover. The pressed part can be pressed by a sliding block at an end of the strip to lower and to restore a position of the pressed part. The elastic connector is configured to pull the cover to close an opening of the curtain container when the arm swings downward. Wherein, the cover rotates upward to open by an elastic torsion force when the sliding block moves upward to detach from the pressed part.

In the linkage mechanism mentioned above, the arm is an elongated rod, is laterally disposed between the lower section of the curtain track and the curtain container, and has two ends. One of the two ends of the arm is connected to the pressed part, and the other one of the two ends of the arm has a pivot portion pivotally connected to a lower section of a wall of the curtain container and being laterally movable. The elastic connector is connected between the arm and the cover.

In the linkage mechanism mentioned above, each of two sides of the lower section of the curtain container has a lateral-guide groove. The pivot portion is pivotally connected to the lateral-guide groove.

In the linkage mechanism mentioned above, the lateral-guide groove is at the wall of the curtain container and has an inserting hole disposed at an end, of the lateral-guide groove, away from the curtain track and having a diameter larger than a width of the lateral-guide groove. A blocking portion is disposed at a terminal end of the pivot portion, has a size larger than the width of the lateral-guide groove, and is configured to be inserted in the inserting hole. The pivot portion can move along the lateral-guide groove, and the blocking portion is restricted at an inner side of the wall of the curtain container.

In the linkage mechanism mentioned above, the arm has an assembling portion adjacent to the pressed part and protruding upward. One of two ends of the elastic connector is connected to the assembling portion, and the other one of the two ends of the elastic connector is connected to the cover.

In the linkage mechanism mentioned above, the linkage unit has an arm and an auxiliary linkage rod. The arm has two ends and a pivot end disposed at one of the two ends of the arm and pivotally connected to the lower section of the curtain track. An assembling portion is disposed at the other one of the two ends of the arm and connected to the elastic connector. The auxiliary linkage rod has two ends, one of the two ends of the auxiliary linkage rod is pivotally connected to the pressed part, and the other one of the two ends of the auxiliary linkage rod is pivotally connected to the arm and adjacent to the assembling portion.

In the linkage mechanism mentioned above, the pressed part has a longitudinal hole passed by a corresponding one of the two cords respectively connected to the two sliding blocks.

In the linkage mechanism mentioned above, the pressed part has a notch formed at a side of the pressed part, extending from a top to a bottom of the pressed part, and communicating with the longitudinal hole.

The linkage mechanism can be applied to the electric sunshade for motorized vehicles, assembled to the curtain track, adjacent to the curtain container, and connected to the cover of the curtain container. The sliding block at the end of the strip of a curtain fabric can move in the curtain track and drive the linkage mechanism to open and close the cover. The linkage mechanism further uses a combination of the linkage unit and the elastic connector. The linkage unit is swingable, disposed between the end of the curtain container and the adjacent curtain track, and under the cover. The pressed part at a side of the arm is disposed at the lower section of the curtain track. The elastic connector is connected between the arm and the cover. Therefore, the arm swings downward when the pressed part is pressed by the sliding block at the end of the strip to pull the cover to close the opening of the curtain container via the elastic connector. The cover rotates upward to open by an elastic torsion force when the sliding block moves upward to detach from the pressed part.

The linkage mechanism further uses the linkage unit to extend a length thereof appropriately to effectively decrease an angle between the elastic connector and the arm connected together. The pressed part is in the curtain track and able to be pressed. The linkage unit is swingable and between the pressed part and the elastic connector. The pressed part cooperates with the linkage unit to let a driving force effectively transmit to the cover when the driving mechanism drives the two ends of the strip of the curtain fabric to move up and down along two said curtain tracks. Interferences of movement of the pressed part inside the curtain track are reduced. The linkage mechanism ensures that the cover opens and closes smoothly.

The pressed part has the longitudinal hole passed through by the cord driving the sliding block. The sliding block driven by the cord directly applies a force to the top of the pressed part. In addition, the notch is formed at the side of the pressed part and extends from the top of the pressed part to the bottom of the pressed part. The cord can be directly inserted in the longitudinal hole of the pressed part from the side of the pressed part via the notch. Convenience of passing the cord through the pressed part is promoted.

Other objects, advantages, and novel features of the invention will become more apparent from the following detailed description when taken in conjunction with the accompanying drawings.

### BRIEF DESCRIPTION OF THE DRAWINGS

FIG. 1 is a first front view of an electric sunshade having a first embodiment of linkage mechanisms in accordance with the present invention assembled to the electric sunshade, showing a curtain fabric of the sunshade is retracted;

FIG. 2 is a first partially enlarged front view of the electric sunshade in FIG. 1, showing one of the linkage mechanisms;

FIG. 3 is a first partially enlarged perspective view of the electric sunshade in FIG. 1, showing one of the linkage mechanisms is partially exploded;

FIG. 4 is a second partially enlarged perspective view of the electric sunshade in FIG. 1;

FIG. 5 is a first side view of the electric sunshade in FIG. 1, showing the curtain fabric is retracted;

FIG. 6 is a second front view of the electric sunshade in FIG. 1, showing the curtain fabric is expanded;

FIG. 7 is a second partially enlarged front view of the electric sunshade in FIG. 1, showing the curtain fabric is expanded;

FIG. 8 is a second side view of the electric sunshade in FIG. 1, showing the curtain fabric is expanded;

FIG. 9 is a first front view of an electric sunshade having a second embodiment of the linkage mechanisms in accordance with the present invention assembled thereto, showing the curtain fabric of the sunshade is retracted;

FIG. 10 is a first partially enlarged front view of the electric sunshade in FIG. 9, showing one of the linkage mechanisms;

FIG. 11 is a first partially enlarged perspective view of the electric sunshade in FIG. 9;

FIG. 12 is a second partially enlarged perspective view of the electric sunshade in FIG. 9;

FIG. 13 is a first side view of the electric sunshade in FIG. 9, showing the curtain fabric is retracted;

FIG. 14 is a second front view of the electric sunshade in FIG. 9, showing the curtain fabric is expanded;

FIG. 15 is a second partially enlarged front view of the electric sunshade in FIG. 9; and

FIG. 16 is a second side view of the electric sunshade in FIG. 9, showing the curtain fabric is expanded.

### DETAILED DESCRIPTION OF PREFERRED EMBODIMENTS

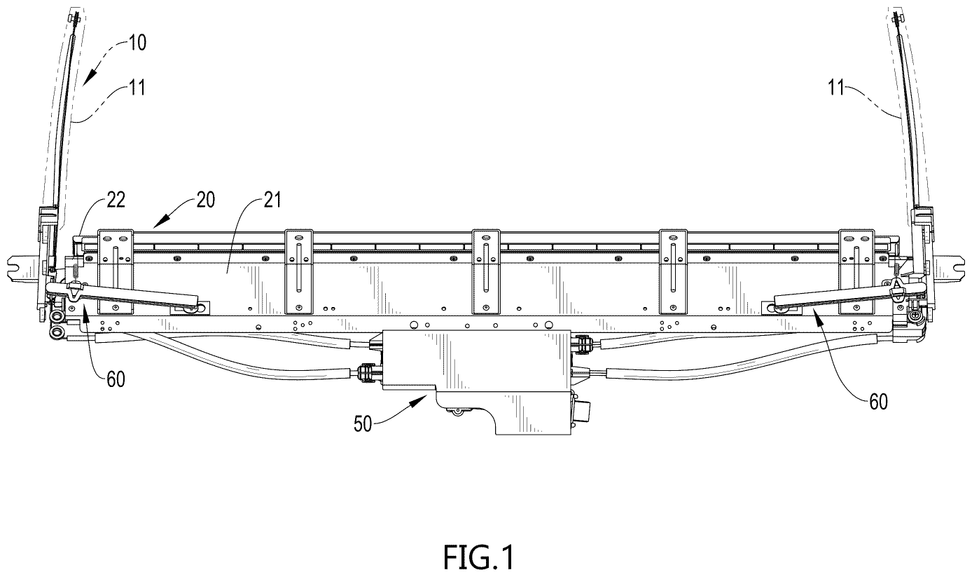

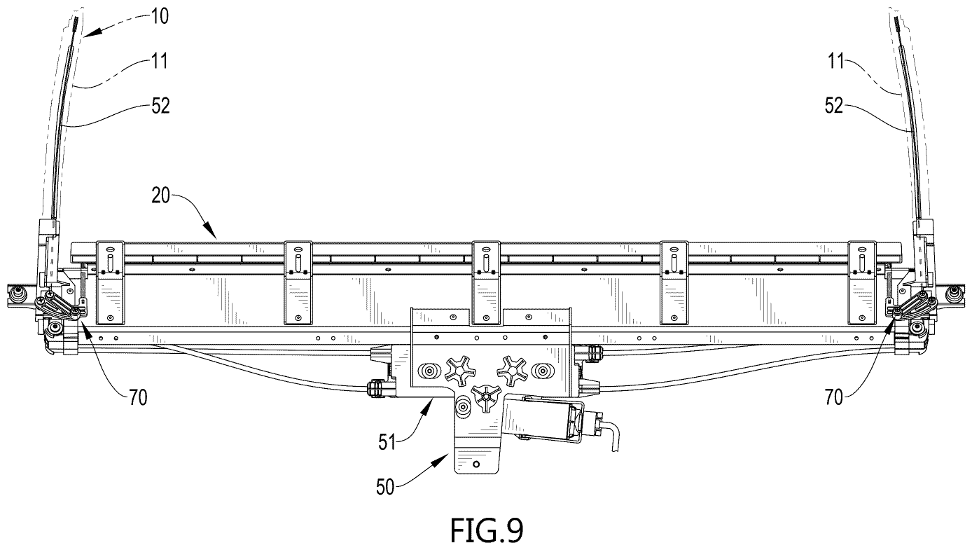

A first embodiment and a second embodiment of the linkage mechanisms 60, 70 in accordance with the present invention assembled to an electric sunshade for a motorized vehicle are respectively shown in FIG. 1 and FIG. 9. The electric sunshade is mounted within a door of the motorized vehicle to provide a sunshade function to the window of the door.

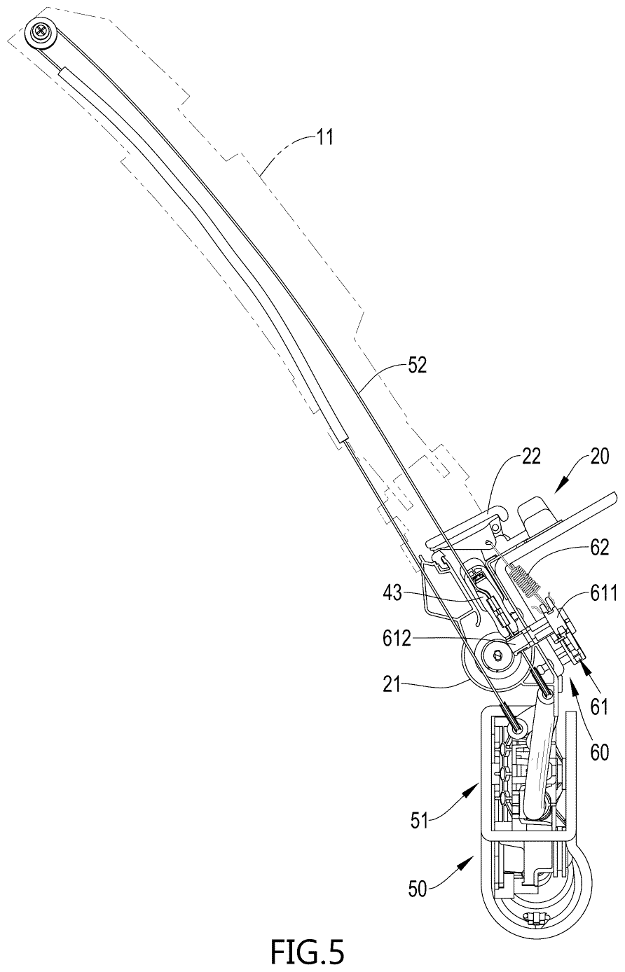

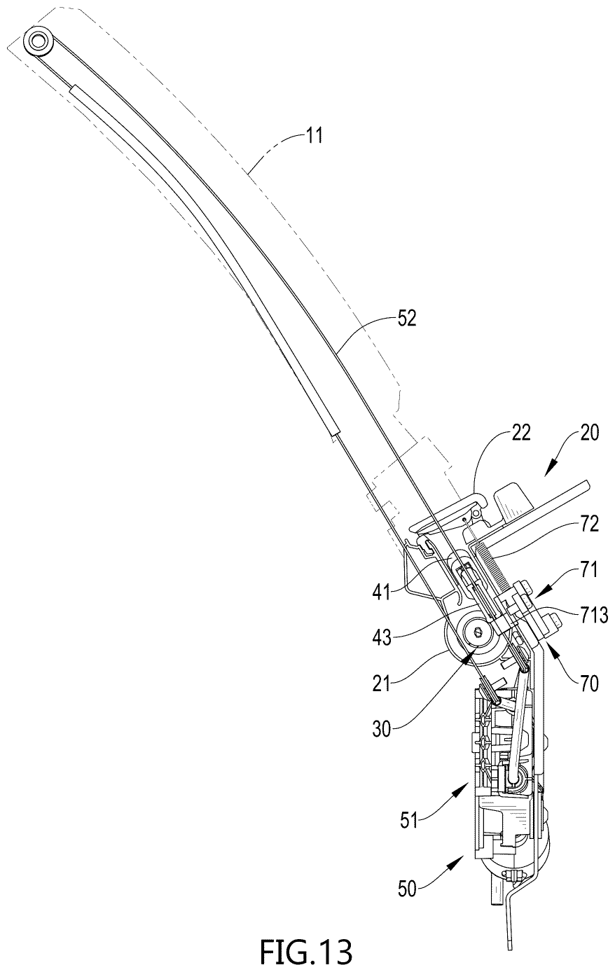

With reference to FIGS. 1, 5, 9, and 13, the electric sunshade has a track set 10, a curtain receiving assembly 20, a retracting assembly 30, a curtain fabric 40, and a driving mechanism 50. The track set 10 has two curtain tracks 11 respectively mounted to two sides of the window of the door. The curtain receiving assembly 20 is mounted under the window of the door and has a curtain container 21 and a cover 22. The curtain container 21 has an opening 211 at a top of the curtain container 21. The cover 22 is pivotally connected to the top of the curtain container 21 via a shaft to open and close the opening 211. One or more torsion springs are connected between the cover 22 and the top of the curtain container 21 to provide torsion forces driving the cover 22 to rotate upward and reveal the opening 211 of the curtain container 21. In the embodiments, the cover 22 has two linking plates 221 respectively at two ends of the cover 22 and protruding downward from a bottom face of the cover 22.

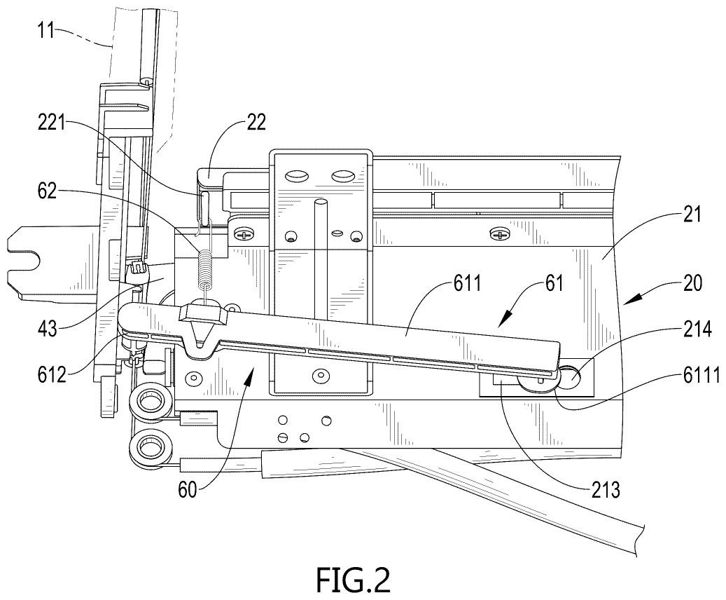

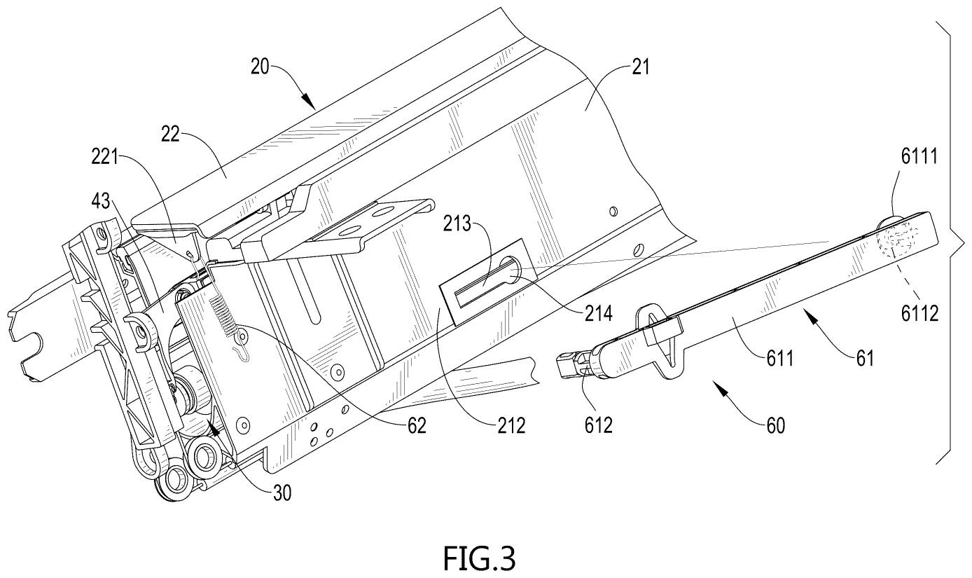

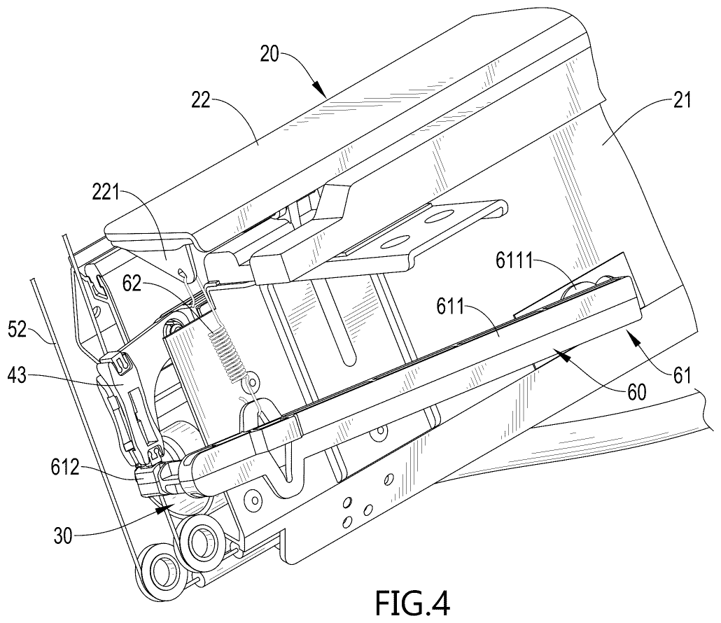

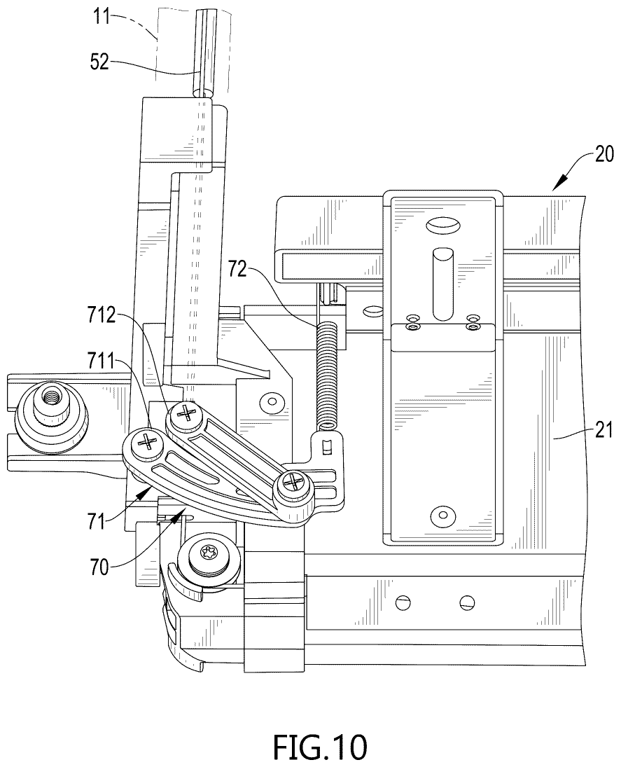

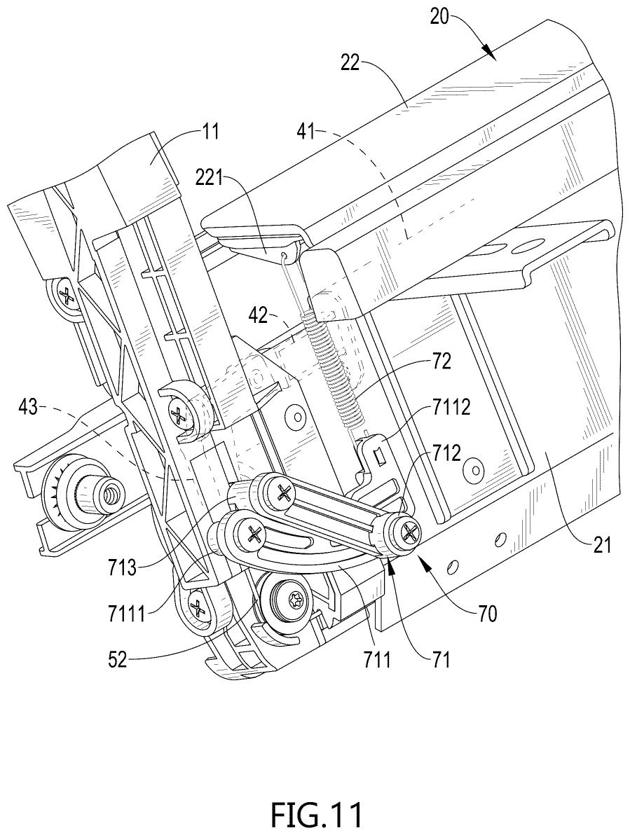

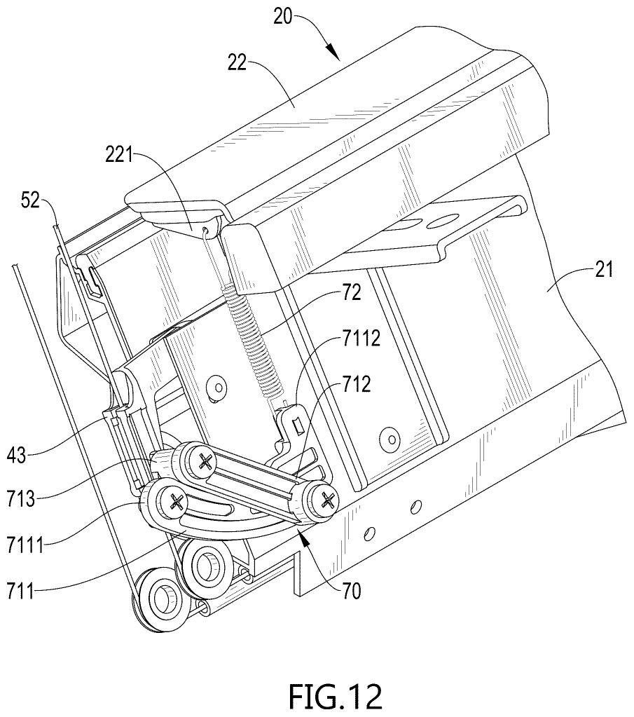

With reference to FIGS. 1 to 5 and FIGS. 9 to 13, the retracting assembly 30 is mounted within the curtain container 21. One of two sides of the curtain fabric 40 is connected to the retracting assembly 30, and the curtain fabric 40 can be retracted by the retracting assembly 30 automatically. The other one of the two sides of the curtain fabric 40 is a moving side with a strip 41. The strip 41 has a length corresponding to a length of the other side that is the moving side of the curtain fabric 40. Basically, the curtain fabric 40 and the window of the door correspond in shape. Since two sides of the window are curved, a top of the curtain fabric 40 is narrower than a bottom thereof when the curtain fabric 40 is expanded. A portion of the curtain fabric 40 between top ends of the two curtain tracks 11 is narrower than a portion between bottom ends of the two curtain tracks 11 accordingly. A length of the strip 41 is smaller than a length of the curtain container 21. Therefore, two sliding blocks 43, laterally movable, are respectively mounted to two ends of the strip 41. The strip 41 moves up and down along the two curtain tracks 11 via the two sliding blocks 43 respectively at the two ends of the strip 41. The curtain fabric 40 can be automatically retracted in the curtain container 21 and be expanded upward from the curtain container 21 by the retracting assembly 30. The retracting assembly 30 may be selected from existing conventional products, and detailed structures of the retracting assembly 30 are not illustrated in the present invention.

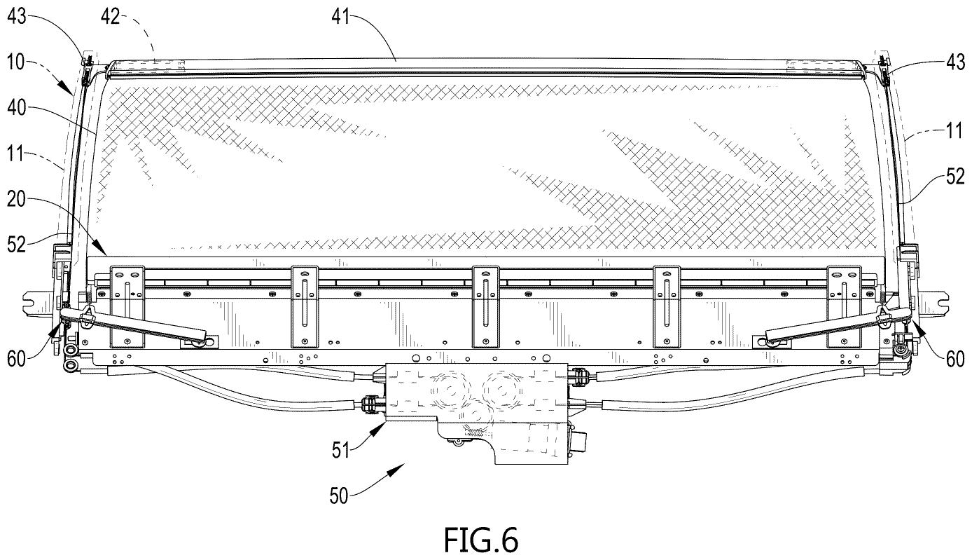

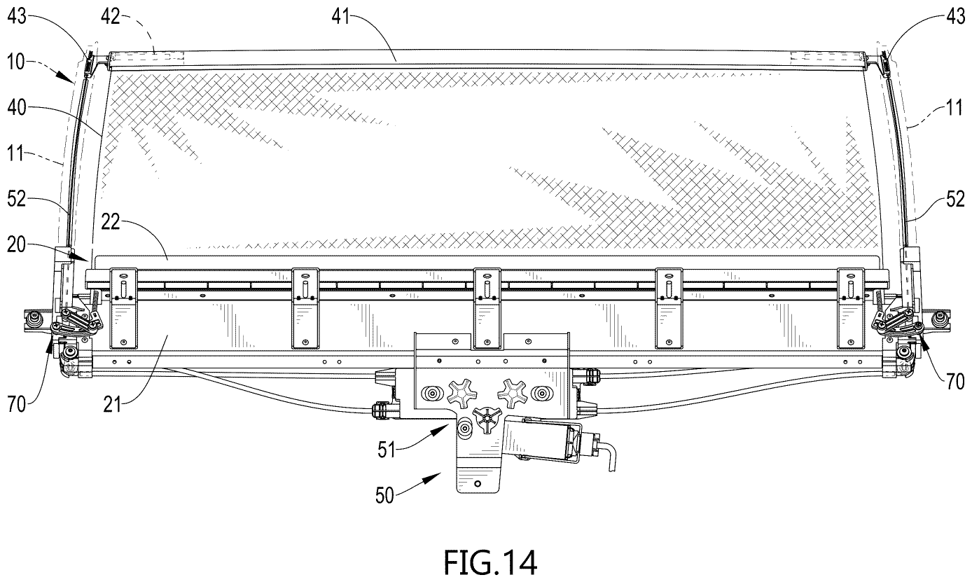

With reference to FIGS. 6 and 14, in the embodiments of the present invention, the two ends of the strip 41 are respectively mounted by two extension rods 42 being laterally retractable. The two sliding blocks 43 are respectively connected to two terminal ends of the two extension rods 42 and move laterally by the length variations of the two extension rods 42 being laterally retractable. The two sliding blocks 43 are kept to move up and down in the two curtain tracks 11 accordingly.

With reference to FIGS. 1 to 5 and FIGS. 9 to 13, the driving mechanism 50 is mounted within the door of the motorized vehicle to drive the two sliding blocks 43 respectively at the two ends of the strip 41 to move up and down. In the embodiments, a driving mechanism with cords can be selected as the driving mechanism 50. The driving mechanism 50 has a pulling set 51 and two cords 52. The pulling set 51 is an existing conventional product, so specific structures of the pulling set 51 is not illustrated in the present invention. The two cords 52 respectively surround the two curtain tracks 11 and are respectively connected to the two sliding blocks 43. The two cords 52 are connected to the pulling set 51 and are totally tightened. The pulling set 51 is configured to pull the two cords 52 forward and backward for driving the two sliding blocks 43 respectively at the two ends of the strip 41 along the two curtain tracks 11 to simultaneously move up and down, and to expand and fold the curtain fabric 40.

With reference to FIGS. 1 to 5 and FIGS. 9 to 13, the linkage mechanism 60/70 is mounted within the door of the motorized vehicle and connected between the cover 22 of the curtain container 21 and the driving mechanism 50. When the curtain fabric 40 is expanded and folded by the driving mechanism 50, the cover 22 automatically opens and closes by the linkage mechanism 60/70. Specific structures of the linkage mechanism 60/70 are illustrated as follows.

With reference to FIGS. 1 and 9, there are two linkage mechanisms 60/70. The two linkage mechanisms 60/70 are respectively assembled between two ends of the curtain container 21 and two lower sections of the two curtain tracks 11.

With reference to FIGS. 1 to 5 and FIGS. 9 to 13, each linkage mechanism 60/70 has a linkage unit 61/71 and an elastic connector 62/72. The linkage unit 61/71 is swingable, disposed between the curtain container 21 and a corresponding one of the two curtain tracks 11, and disposed under the cover 22. The linkage unit 61/71 has an arm 611/711 and a pressed part 612/713. The pressed part 612/713 is disposed at a side of the arm 611/711. The elastic connector 62/72 is connected between the arm 611/711 and the cover 22. Preferably, the elastic connector 62/72 may be an elastic component such as an extension spring, an elastic band and so on.

The pressed part 612/713 of the linkage unit 61/71 is inserted inside a lower section of a corresponding one of the two curtain tracks 11. The pressed part 612/713 can be pressed by the sliding block 43 at a corresponding one of the two ends of the strip 41 to lower a position of the pressed part 612/713, and the pressed part 612/713 can restore. The arm 611/711 swings downward and pulls the cover 22 via the elastic connector 62/72 to close the opening 211 of the curtain container 21, and the torsion springs between the curtain container 21 and the cover 22 accumulate torsional elastic energy. When the sliding block 43 moves upward and detaches from the pressed part 612/713, the torsion springs between the curtain container 21 and the cover 22 provide elastic torsions to drive the cover 22 to rotate upward to open. The linkage unit 61/71 with the sliding block 43 is driven by the elastic connector 62/72 to restore simultaneously.

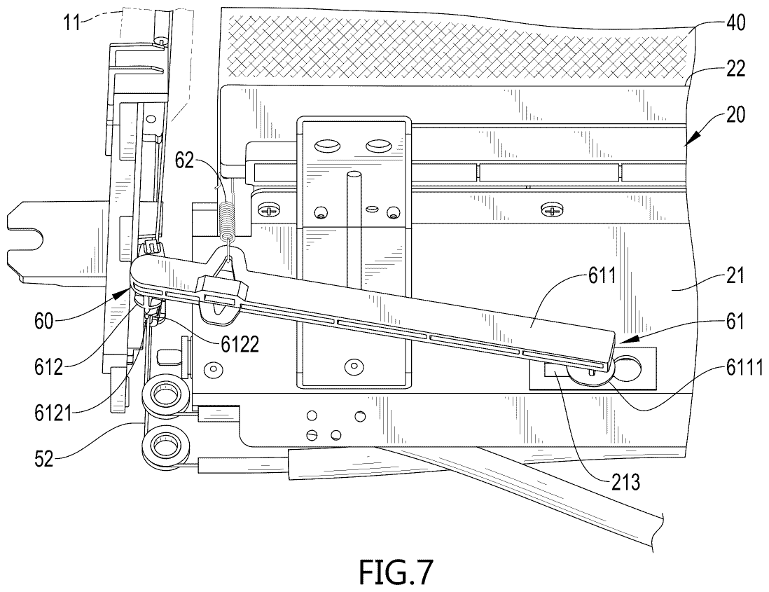

Preferably, with reference to FIG. 7, the pressed unit 612/713 has a longitudinal hole 6121. A corresponding one of the two cords 52 driving the sliding block 43 passes through the longitudinal hole 6121. The sliding block 43 driven by the cord 52 can directly press the pressed part 612/713 such that a force of the sliding block 43 pressing the pressed part 612/713 is directly applied to a top of the pressed part 612/713. In addition, the pressed part 612/713 further has a notch 6122 formed at a side of the pressed part 612/713 and extending from the top of the pressed part 612/713 to a bottom of the pressed part 612/713. The cord 52 can be directly inserted in the longitudinal hole 6121 of the pressed part 612/713 from the side of the pressed part 612/713 via the notch 6122. Convenience of passing the cord 52 through the pressed part 612/713 is promoted.

In the first embodiment shown in FIGS. 1 to 5, the linkage unit 61 is selected as an elongated rod structure and suitable for a circumstance having a larger installation space inside the door of the motorized vehicle. The linkage unit 61 has the arm 611 being an elongated rod. The arm 611 is laterally disposed between the lower section of the curtain track 11 and the curtain container 21. The arm 611 has two ends opposite to each other. The pressed part 612 is disposed at one of the two ends of the arm 611, and the other one of the two ends of the arm 611 has a pivot portion 6111. The pressed part 612 extends into the lower section of the curtain track 11. The pivot portion 6111 is laterally movable and pivotally connected to a lower section of a wall 212 of the curtain container 21. The elastic connector 62 is connected between the arm 611 and the cover 22. Preferably, the arm 611 has an assembling portion adjacent to the pressed part 612 and protruding upward. One of two ends of the elastic connector 62 is connected to the assembling portion, and the other one of the two ends of the elastic connector 62 is connected to the linking plate 221 at the bottom face of the cover 22.

Two lateral-guide grooves 213 are respectively disposed at two sides of the lower section of the wall 212 of the curtain container 21. The pivot portion 6111 is inserted in a corresponding one of the two lateral-guide grooves 213. In the first embodiment, the lateral-guide groove 213 at the wall 212 of the curtain container 21 has an inserting hole 214 disposed at an end, of the lateral-guide groove 213, away from the curtain track 11. The inserting hole 214 has a diameter larger than a width of the lateral-guide groove 213. A blocking portion 6112 is disposed at a terminal end of the pivot portion 6111 and has a size larger than the width of the lateral-guide groove 213. The blocking portion 6112 at the terminal end of the pivot portion 6111 can be inserted through the inserting hole 214. The blocking portion 6112 is blocked by the inner side of the wall 212. The pivot portion 6111 can move along the lateral-guide groove 213 accordingly and is kept from detaching from the lateral-guide groove 213.

In the second embodiment shown in FIGS. 9 to 13, the linkage unit 71 is selected as a short rod structure and suitable for a small installation space inside the door of the motorized vehicle. The linkage unit 71 has the arm 711 and an auxiliary linkage rod 712. One of the two ends of the arm 711 is a pivot end 7111, and the other one of the two ends of the arm 711 is an assembling portion 7112. The pivot end 7111 is pivotally connected to the lower section of the curtain track 11. Preferably, the pivot end 7111 is disposed under the pressed part 713. One of the two ends of the elastic connector 72 is connected to the assembling portion 7112, and the other one of the two ends of the elastic connector 72 is connected to the linking plate 221 at the bottom face of the cover 22. One of two ends of the auxiliary linkage rod 712 is pivotally connected to the pressed part 713. The auxiliary linkage rod 712 inclines downward, and the other one of the two ends of the auxiliary linkage rod 712 is pivotally connected to the arm 711 and adjacent to the assembling portion 7112.

Operations of the linkage mechanism 60/70 applied to the electric sunshade of the motorized vehicle are shown in FIGS. 1 to 5 and FIGS. 9 to 13. When the curtain fabric 40 is folded, the pulling set 51 pulls the two cords 52 backward to apply downward forces to the two sliding blocks 43 at the two ends of the strip 41 of the curtain fabric 40. The pulling set 51 cooperates with automatic retracting force to the curtain fabric 40 from the retracting assembly 30 to retract the curtain fabric 40 into the curtain container 21. The pulling set 51 stops pulling when the strip 41 enters the curtain container 21. Meanwhile, the two sliding blocks 43 at the two ends of the strip 41 subjected to the downward forces respectively apply downward forces to the two pressed parts 612/713 of the two linkage units 61/71 at the two lower sections of the two curtain tracks 11. Each linkage unit 61/71 drives the elastic connector 62/72 at the same time and pulls the cover 22 to close the opening 211 of the curtain container 21 via the elastic connector 62/72. The torsion springs accumulate torsion elastic energy accordingly.

As the first embodiment mentioned above, with reference to FIGS. 1 to 5, when the linkage unit 61 is implemented as the elongated rod structure, the sliding block 43 driven by the cord 52 presses the pressed part 612 inserted in the lower section of the curtain track 11. One of the two ends of the arm 611 moves downward with the pressed part 612, the other one of the two ends of the arm 611 slides along the lateral-guide groove 213 at the lower section of the wall 212 of the curtain container 21. The arm 611 applies a downward force to the cover 22 via the elastic connector 62 to overcome the torsion forces applied to the cover 22. The cover 22 is pulled downward to close the opening 211 of the curtain container 21.

With reference to FIGS. 9 to 13, when the linkage unit 71 is implemented as the short rod structure, the sliding block 43 driven by the cord 52 presses the pressed part 713 inserted in the lower section of the curtain track 11. The auxiliary linkage rod 712 pivotally connected to the pressed part 713 applies a downward force to one of the two ends of the arm 711 having the assembling portion 7112. The pivot end 7111 of the arm 711 pivotally connected to the curtain track 11 is a fulcrum for the arm 711 to rotate downward. The arm 711 applies a downward force to the cover 22 via the elastic connector 72 to overcome the torsion forces applied to the cover 22. The cover 22 is pulled downward to close the opening 211 of the curtain container 21 accordingly.

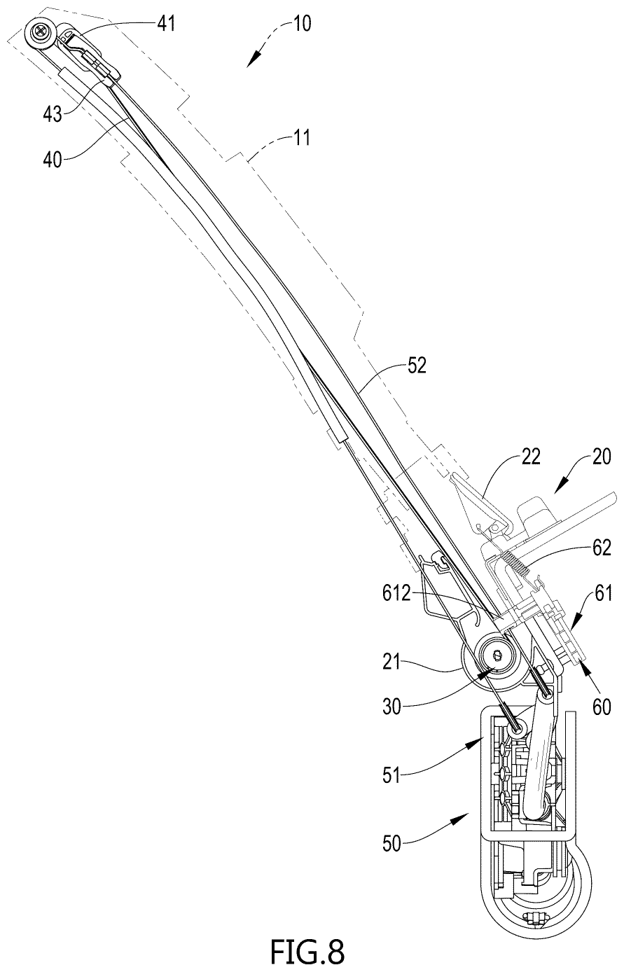

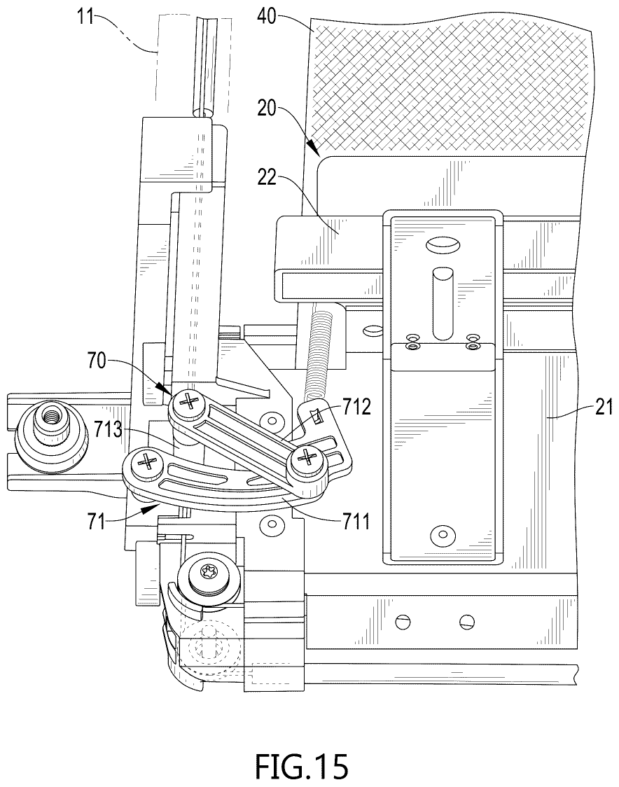

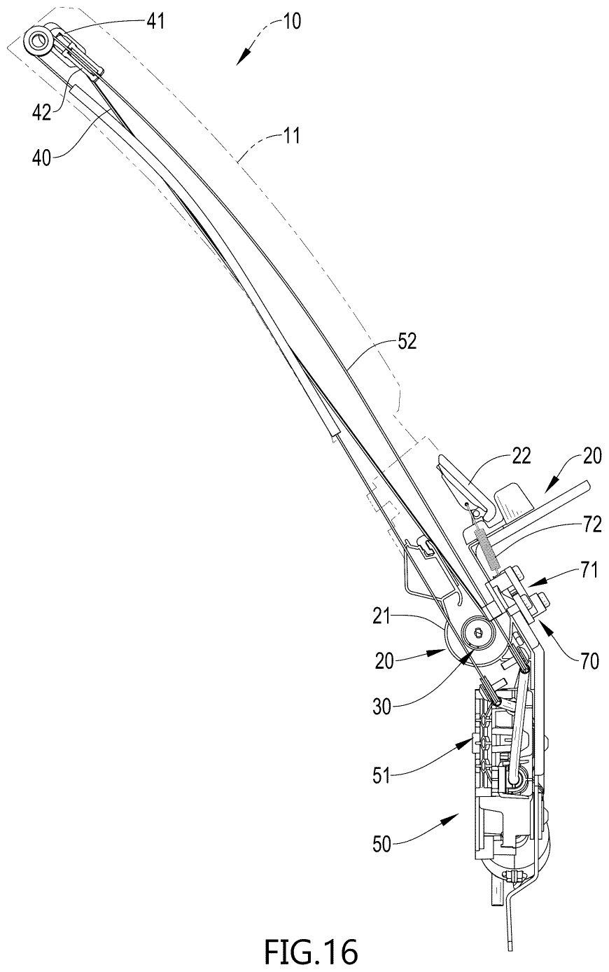

With reference to FIGS. 6 to 8 and FIGS. 14 to 16, the curtain fabric 40 is expanded to shade the window of the motorized vehicle. The pulling set 51 of the driving mechanism 50 pulls the two cords 52 forward to drive the two sliding blocks 43 at the two ends of the strip 41 of the curtain fabric 40 to move up along the two curtain tracks 11. When each sliding block 43 moves upward, the downward force applied to the pressed part 612/713 vanishes. The cover 22 closing the top of the curtain container 21 rotates upward due to the torsion forces of the torsion springs. The cover 22 opens the opening 211 of the curtain container 21 at first and maintains the opening condition. The pressed part 612/713, of the linkage unit 61/71, inserted in the lower section of the curtain track 11, moves up with the cover 22 rotating upward and stops at a determined position. The strip 41, of the curtain fabric 40, retracted in the curtain container 21 is subjected to upward forces from the cords 52 of the driving mechanism 50. The curtain fabric 40 overcomes the retracting force provided by the retracting assembly 30 and moves up through the opening 211 of the curtain container 21. Till the curtain fabric 40 is fully expanded, the driving mechanism 50 is turned off, and the curtain fabric 40 shades the sunlight at a lateral side of the window of the motorized vehicle.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A linkage mechanism to drive a cover of a curtain container of an electric sunshade for a motorized vehicle, the linkage mechanism configured to be assembled to an electric sunshade at a window of a motorized vehicle, disposed between a lower section of a curtain track beside the window and a curtain container under the window; the linkage mechanism connected to a cover, at a top of the curtain container, driven by an elastic torsion force; a strip of a curtain fabric of the electric sunshade configured to be driven by a driving mechanism to go up and down, two cords of the driving mechanism respectively connected to two sliding blocks at two ends of the strip, one of the sliding blocks moving along the curtain track driving the curtain fabric to expand and fold; the linkage mechanism driving the cover to close and open an opening at the top of the curtain container and the linkage mechanism having
a linkage unit being swingable, disposed between an end of the curtain container and the curtain track, being under the cover, and having
an arm; and
a pressed part disposed at a side of the arm and at the lower section of the curtain track; and
an elastic connector connected between the arm and the cover such that the pressed part is able to be pressed by the sliding block at one of the two ends of the strip to lower and to restore a position of the pressed part;
the elastic connector configured to pull the cover to close the opening of the curtain container when the arm swings downward; wherein,
the cover rotates upward to open by the elastic torsion force when the sliding block moves upward to detach from the pressed part.

2. The linkage mechanism as claimed in claim 1, wherein
the arm is an elongated rod, is laterally disposed between the lower section of the curtain track and the curtain container, and has two ends;
one of the two ends of the arm is connected to the pressed part, and the other one of the two ends of the arm has a pivot portion pivotally connected to a lower section of a wall of the curtain container and is laterally movable; and
the elastic connector is connected between the arm and the cover.

3. The linkage mechanism as claimed in claim 2, wherein
each of two sides of the lower section of the curtain container has a lateral-guide groove; and
the pivot portion is pivotally connected to the lateral-guide groove.

4. The linkage mechanism as claimed in claim 3, wherein
the lateral-guide groove at the wall of the curtain container has an inserting hole disposed at an end, of the lateral-guide groove, said end away from the curtain track and having a diameter larger than a width of the lateral-guide groove;
a blocking portion is disposed at a terminal end of the pivot portion, has a size larger than the width of the lateral-guide groove, and is configured to be inserted in the inserting hole; and
the pivot portion is moveable along the lateral-guide groove, and the blocking portion is restricted at an inner side of the wall of the curtain container.

5. The linkage mechanism as claimed in claim 4, wherein
the arm has an assembling portion adjacent to the pressed part and protruding upward; and
one of two ends of the elastic connector is connected to the assembling portion, and the other one of the two ends of the elastic connector is connected to the cover.

6. The linkage mechanism as claimed in claim 1, wherein
the linkage unit has
an arm having
two ends, one of the two ends being a pivot end, and the pivot end pivotally connected to the lower section of the curtain track; and
an assembling portion disposed at the other one of the two ends of the arm and connected to the elastic connector; and
an auxiliary linkage rod having
two ends, one of the two ends of the auxiliary linkage rod pivotally connected to the pressed part, the other one of the two ends of the auxiliary linkage rod pivotally connected to the arm and adjacent to the assembling portion.

7. The linkage mechanism as claimed in claim 1, wherein the pressed part has a longitudinal hole passed by a corresponding one of the two cords respectively connected to the two sliding blocks.

8. The linkage mechanism as claimed in claim 2, wherein the pressed part has a longitudinal hole passed by a corresponding one of the two cords respectively connected to the two sliding blocks.

9. The linkage mechanism as claimed in claim 3, wherein the pressed part has a longitudinal hole passed by a corresponding one of the two cords respectively connected to the two sliding blocks.

10. The linkage mechanism as claimed in claim 4, wherein the pressed part has a longitudinal hole passed by a corresponding one of the two cords respectively connected to the two sliding blocks.

11. The linkage mechanism as claimed in claim 5, wherein the pressed part has a longitudinal hole passed by a corresponding one of the two cords respectively connected to the two sliding blocks.

12. The linkage mechanism as claimed in claim 6, wherein the pressed part has a longitudinal hole passed by a corresponding one of the two cords respectively connected to the two sliding blocks.

13. The linkage mechanism as claimed in claim 7, wherein the pressed part has a notch formed at a side of the pressed part, extending from a top to a bottom of the pressed part, and connecting with the longitudinal hole.

14. The linkage mechanism as claimed in claim 8, wherein the pressed part has a notch formed at a side of the pressed part, extending from a top to a bottom of the pressed part, and connecting with the longitudinal hole.

15. The linkage mechanism as claimed in claim 9, wherein the pressed part has a notch formed at a side of the pressed part, extending from a top to a bottom of the pressed part, and connecting with the longitudinal hole.

16. The linkage mechanism as claimed in claim 10, wherein the pressed part has a notch formed at a side of the pressed part, extending from a top to a bottom of the pressed part, and connecting with the longitudinal hole.

17. The linkage mechanism as claimed in claim 11, wherein the pressed part has a notch formed at a side of the pressed part, extending from a top to a bottom of the pressed part, and connecting with the longitudinal hole.

18. The linkage mechanism as claimed in claim 12, wherein the pressed part has a notch formed at a side of the pressed part, extending from a top to a bottom of the pressed part, and connecting with the longitudinal hole.
